(19) United States
(12) Patent Application Publication
(10) Pub. No.: US 2016/0142691 A1
(43) Pub. Date: May 19, 2016

(54) IMAGE PROCESSING APPARATUS, IMAGE PROJECTION SYSTEM, IMAGE PROCESSING METHOD, AND COMPUTER PROGRAM PRODUCT

(71) Applicant: KABUSHIKI KAISHA TOSHIBA, Tokyo (JP)

(72) Inventors: Hisashi KOBIKI, Kawasaki (JP); Mikiko KARASAWA, Tokyo (JP); Yuma SANO, Kawasaki (JP); Wataru WATANABE, Kawasaki (JP); Yasutoyo TAKEYAMA, Kawasaki (JP); Masahiro BABA, Yokohama (JP)

(21) Appl. No.: 14/878,373

(22) Filed: Oct. 8, 2015

(30) Foreign Application Priority Data
Nov. 17, 2014 (JP) 2014-232982

(51) Int. Cl. H04N 9/31; H04N 5/232

(52) U.S. Cl. CPC H04N 9/3182; H04N 9/3185; H04N 5/23229

(57) ABSTRACT

According to an embodiment, an image processing apparatus includes a corresponding point calculator, a parameter calculator, a corrector, and a detector. The corresponding point calculator calculates corresponding points between an input image and a captured image including a projection surface onto which a projection image is projected. The projection image is generated from the input image. The parameter calculator calculates a correction parameter based on the input image, the captured image, and the corresponding points. The corrector corrects pixel values of the input image using the correction parameter with respect to each color component. The detector detects a change in the projection surface. When the detector detects the change in the projection surface, the corresponding point calculator updates the corresponding points for the change, and the parameter calculator calculates the correction parameter based on the updated corresponding points.

### CROSS-REFERENCE TO RELATED APPLICATIONS

This application is based upon and claims the benefit of priority from Japanese Patent Application No. 2014-232982, filed on Nov. 17, 2014; the entire contents of which are incorporated herein by reference.

### FIELD

Embodiments described herein relate generally to an image processing apparatus, an image projection system, an image processing method, and a computer program product.

### BACKGROUND

There have been developed technologies for reducing an influence of a color and a pattern of a projection surface on a view of a projection image in image projection systems. The technologies reduce the influence by the following: calculating a correction parameter by comparing a captured image obtained by capturing the projection surface onto which the projection image is projected with an input image serving as the original of the projection image; and correcting pixel values of respective color components in the input image with the correction parameter. To dynamically perform such correction, the correction parameter depending on the reflection characteristics of the projection surface is calculated and updated for each frame of the input image.

To calculate the correction parameter by comparing the captured image of the projection surface with the input image in this processing, it is necessary to know the corresponding points between the input image and the captured image of the projection surface. If the relative positional relation between a projection apparatus that projects the projection image and the projection surface is fixed, it is possible to calculate in advance the corresponding points between the input image and the captured image of the projection surface. However, if the relative positional relation between the projection apparatus and the projection surface is changed, the corresponding points are changed. As a result, an erroneous correction parameter may possibly be calculated, resulting in failed correction. To address this, it is necessary to calculate a correct correction parameter and perform appropriate correction even when the relative positional relation between the projection apparatus and the projection surface is changed.

### BRIEF DESCRIPTION OF THE DRAWINGS

FIG. 1 is a block diagram of an image projection system according to a first embodiment;

FIG. 2 is a flowchart performed by an image processing apparatus according to the first embodiment;

FIG. 3 is a block diagram of an image projection system according to a second embodiment;

FIG. 4 is a flowchart performed by an image processing apparatus according to the second embodiment;

FIG. 5 is a block diagram of an image projection system according to a third embodiment;

FIG. 6 is a flowchart performed by an image processing apparatus according to the third embodiment;

FIG. 7 is a block diagram of an image projection system according to a fourth embodiment; and

FIG. 8 is a block diagram of an exemplary hardware configuration of the image processing apparatus.

### DETAILED DESCRIPTION

According to an embodiment, an image processing apparatus includes a corresponding point calculator, a parameter calculator, a corrector, and a detector. The corresponding point calculator calculates corresponding points between an input image and a captured image including a projection surface onto which a projection image is projected. The projection image is generated from the input image. The parameter calculator calculates a correction parameter based on the input image, the captured image, and the corresponding points. The corrector corrects pixel values of the input image using the correction parameter with respect to each color component. The detector detects a change in the projection surface. When the detector detects the change in the projection surface, the corresponding point calculator updates the corresponding points for the change, and the parameter calculator calculates the correction parameter based on the updated corresponding points.

### First Embodiment

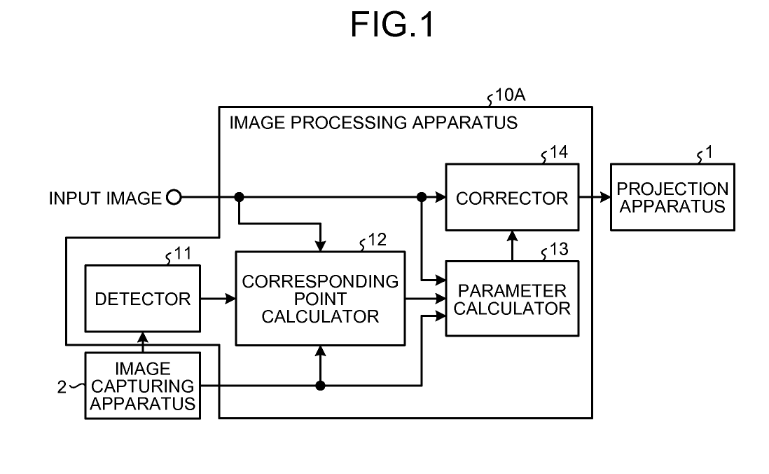

FIG. 1 is a block diagram of an image projection system according to a first embodiment. As illustrated in FIG. 1, the image projection system according to the present embodiment includes a projection apparatus 1, an image capturing apparatus 2, and an image processing apparatus 10A.

The projection apparatus 1 projects a projection image corresponding to an input image onto a projection surface. The projection apparatus 1 may be any known projection apparatus, such as a liquid-crystal projector and a laser projector, as long as it projects the projection image onto the projection surface. While the projection apparatus 1 according to the present embodiment is an external apparatus connected to the image processing apparatus 10A, for example, the image processing apparatus 10A may be integrated with the projection apparatus 1. The image processing apparatus 10A, for example, may be provided in a housing of the projection apparatus 1.

The projection surface onto which the projection image is projected by the projection apparatus 1 according to the present embodiment is not limited to a typical projection screen. The projection surface may be the surfaces of various objects, such as interior and exterior structures including walls, floors, and ceilings, various types of equipment including desks, merchandise display shelves, curtains, and partitions, and moving objects including planes, ships, railway trains, buses, cars, and monorail trains. These projection surfaces frequently have a color and a pattern appearing because of the material, the shape, and the base pattern of the object, for example. To reduce an influence of the color and the pattern of the projection surface on the view of the projection image, the image processing apparatus 10A of the image projection system according to the present embodiment corrects the input image using a correction parameter depending on the reflection characteristics of the projection surface (distribution of the reflectance of color components in the plane of the projection surface). The projection apparatus 1 projects a projection image corresponding to the input image corrected by the image processing apparatus 10A onto the projection surface.

The image capturing apparatus 2 captures the projection surface including at least an area onto which the projection image is projected and outputs the captured image to the image processing apparatus 10A. In a case where the projection apparatus 1 projects a visible light projection image onto the projection surface, for example, the image capturing apparatus 2 captures the projection surface including the area onto which the visible light projection image is projected and outputs the captured image to the image processing apparatus 10A. In a case where the projection apparatus 1 projects an invisible light projection image, such as a pattern for calibration, which will be described later, different from the visible light projection image for display onto the projection surface, for example, the image capturing apparatus 2 captures the projection surface including the area onto which the invisible light projection image is projected and outputs the captured image to the image processing apparatus 10A.

As described above, the brightness and the color of the projection image projected onto the projection surface by the projection apparatus 1 are changed by the influence of the color and the pattern of the projection surface (an effect of the reflection characteristics of the projection surface). The change in the brightness and the color of the projection surface can be detected by comparing the input image serving as the original of the projection image with the captured image of the projection surface captured by the image capturing apparatus 2. The image projection system according to the present embodiment transmits the captured image of the projection surface captured by the image capturing apparatus 2 to the image processing apparatus 10A. The image processing apparatus 10A calculates a correction parameter depending on the reflection characteristics of the projection surface and corrects the input image using the correction parameter. That is, the image processing apparatus 10A corrects pixel values of the input image with respect to each color component so as to cancel the effect of reflection characteristics of the projection surface. The projection apparatus 1 projects a projection image corresponding to the input image corrected by the image processing apparatus 10A onto the projection surface. Thus, the projection apparatus 1 can project, onto the projection surface, a desired projection image in which a change in the brightness and the color due to the influence of the color and the pattern of the projection surface is canceled out.

While the image capturing apparatus 2 according to the present embodiment is an external apparatus connected to the image processing apparatus 10A, for example, the image processing apparatus 10A may be integrated with the image capturing apparatus 2. The image processing apparatus 10A, for example, may be provided in a housing of the image capturing apparatus 2. The image capturing apparatus 2 may be integrated with the projection apparatus 1. Alternatively, the projection apparatus 1, the image capturing apparatus 2, and the image processing apparatus 10A may be integrated.

The image processing apparatus 10A compares the input image serving as the original of the projection image with the captured image of the projection surface captured by the image capturing apparatus 2, thereby calculating the correction parameter. The image processing apparatus 10A corrects the input image using the calculated correction parameter and outputs the corrected input image to the projection apparatus 1.

The signals of the input image may have various forms. In the present embodiment, each pixel has the luminance of three channels of a red component, a green component, and a blue component as pixel values. The luminance of each channel may be calculated by linearly transforming a non-linear gradation pixel value. The luminance of each channel may be calculated from input signals conforming to the YCbCr transmission standard of the International Telecommunication Union (ITU), for example. The input image may be input from any device or medium. In other words, the input image may be input from a storage device, such as a hard disk drive (HDD), from an external device connected via a network, or from broadcast waves of television, for example.

To calculate the correction parameter by comparing the input image with the captured image of the projection surface, it is necessary to know the corresponding points between the input image and the captured image of the projection surface. A case is assumed where the image capturing apparatus 2 that captures the projection surface is fixed. If the relative positional relation between the projection apparatus 1 and the projection surface is not changed, the corresponding points between the input image and the captured image of the projection surface, which is calculated in advance as a fixed value, can be used. By contrast, if the relative positional relation between the projection apparatus 1 and the projection surface is changed, the corresponding points are changed. The use of the correspondence relation calculated in advance may possibly lead to calculation of an erroneous correction parameter, resulting in failed correction. Particularly, the projection surface according to the present embodiment assumes the surfaces of various objects including moving objects, and thus the relative positional relation between the projection apparatus 1 and the projection surface may frequently be changed.

To address this, the image processing apparatus 10A according to the present embodiment has the following functions: a function to detect a change in the relative positional relation between the projection apparatus 1 and the projection surface; and a function to update, when the change is detected, the corresponding points between the input image and the captured image of the projection surface. If a change in the relative positional relation between the projection apparatus 1 and the projection surface is detected, the image processing apparatus 10A calculates a correction parameter using the updated corresponding points. The following describes the image processing apparatus 10A in detail.

The projection apparatus 1 according to the embodiments below is fixed to a structure such as a ceiling of a building, and does not move. The embodiments below detect a change in the projection surface as a change in the relative positional relation between the projection apparatus 1 and the projection surface. In a case when detecting a change in the relative positional relation between the projection apparatus 1 and the projection surface, which includes movement of the projection apparatus 1, a “change in the projection surface” in the following description may be replaced by a “change in the relative positional relation between the projection apparatus 1 and the projection surface”.

As illustrated in FIG. 1, the image processing apparatus 10A according to the present embodiment includes a detector 11, a corresponding point calculator 12, a parameter calculator 13, and a corrector 14.

The detector 11 detects a change in the projection surface. A change in the projection surface indicates a phenomenon that causes a change in the positional relation of the projection surface with respect to the projection apparatus 1. Examples of the change in the projection surface include, but are not limited to, movement of the projection surface such as rotation and translation not associated with rotation, and replacement of the projection surface (replacement of the projection surface with another projection surface).

The detector 11, for example, detects a change in the projection surface using the captured image of the projection surface received from the image capturing apparatus 2. Specifically, the detector 11 calculates a temporal variation of a part or the whole of the captured image of the projection surface with no change occurring in the input image, for example. If the calculated temporal variation exceeds a predetermined threshold, the detector 11 determines that the projection surface is changed. The temporal variation of the captured image, for example, is calculated by accumulating variations in the captured images of a certain number of frames. The detector 11 analyzes the captured images for each predetermined number of frames, thereby determining whether the projection surface is changed. If the detector 11 determines that the projection surface is changed, the detector 11 outputs change information indicating presence of a change to the corresponding point calculator 12. If the detector 11 determines that the projection surface is not changed, the detector 11 outputs change information indicating absence of a change to the corresponding point calculator 12.

If the detector 11 detects a change in the projection surface, the corresponding point calculator 12 uses the captured image of the changed projection surface and the input image at that time, thereby calculating the corresponding points between the input image and the captured image of the projection surface. In other words, if the change information received from the detector 11 indicates that the projection surface is changed, the corresponding point calculator 12 uses the captured image of the projection surface received from the image capturing apparatus 2 and the input image, thereby calculating new corresponding points corresponding to the captured image obtained after the projection surface is changed. If the corresponding point calculator 12 calculates new corresponding points, the corresponding point calculator 12 outputs the new corresponding points to the parameter calculator 13. By contrast, if the change information received from the detector 11 indicates that the projection surface is not changed, and if the corresponding point calculator 12 does not calculate new corresponding points, the corresponding point calculator 12 outputs previous corresponding points stored in a certain storage area inside or outside the image processing apparatus 10A to the parameter calculator 13. That is, when the detector 11 detects the change in the projection surface, the corresponding point calculator 12 calculates new corresponding points so as to update the previous corresponding points, and outputs the updated corresponding points to the parameter calculator 13.

The corresponding points according to the present embodiment indicates, when a ray of a certain pixel (target pixel) in the input image output from the projection apparatus 1 is incident on and reflected by the projection surface, the correspondence relation between the position of the target pixel in the captured image obtained by capturing the projection surface and the position of the target pixel in the input image. The corresponding points can be generated by a typical corresponding point search method, for example. Specifically, the corresponding point calculator 12 calculates luminance gradient near the target pixel using information on a pixel near the target pixel in the input image. Subsequently, the corresponding point calculator 12 performs projective transformation such that the captured image directly faces the image capturing apparatus 2 using information on a predetermined positional relation between the image capturing apparatus 2 and the projection apparatus 1. Finally, the corresponding point calculator 12 detects, from the captured image subjected to the projective transformation, a pixel having luminance gradient similar to that near the target pixel in the input image and calculates a pair of the detected pixel and the target pixel in the input image as a corresponding point. The corresponding point calculator 12 calculates a corresponding point for all the pixels of the input image.

The corresponding point calculator 12 may calculate the corresponding points on the basis of a captured image of the projection surface onto which an invisible light projection image is projected and an input image corresponding to the invisible light projection image. The invisible light is light having a wavelength outside the visible range such as infrared rays and ultraviolet rays. The invisible light projection image is projected onto the projection surface by a projection apparatus different from the projection apparatus 1, for example, as an image for calibration different from a typical visible light projection image for display. Alternatively, the projection apparatus 1 may have a function to project an invisible light projection image onto the projection surface. The captured image of the projection surface onto which the invisible light projection image is projected may be captured by an image capturing apparatus different from the image capturing apparatus 2. Alternatively, the image capturing apparatus 2 may have a function to capture invisible light. Because typical invisible light cannot be seen with the human eye, the use of invisible light makes it possible to project and capture a pattern without obstructing the visible light projection image for display projected by the projection apparatus 1. By using a pattern for calibration such as a grid pattern and a dot pattern as the invisible light projection image, it is possible to calculate the corresponding points with high accuracy.

As described above, if the projection surface is changed, the detector 11 and the corresponding point calculator 12 of the image processing apparatus 10A according to the present embodiment updates the corresponding points so as to respond to the captured image obtained after the projection surface is changed, whereas if the projection surface is not changed, the corresponding points are not updated. This makes it possible to always appropriately retain the corresponding points between the input image and the captured image of the projection surface, and thus enables the parameter calculator 13, which will be described later, to correctly calculate a correction parameter even when the projection surface is changed.

The parameter calculator 13 calculates a correction parameter on the basis of the input image, the captured image of the projection surface received from the image capturing apparatus 2, and the corresponding points received from the corresponding point calculator 12. The parameter calculator 13 outputs the calculated correction parameter to the corrector 14. At this time, if the detector 11 detects a change in the projection surface, and if the corresponding point calculator 12 calculates new corresponding points corresponding to the captured image obtained after the projection surface is changed and updates the previous corresponding points, the parameter calculator 13 calculates and outputs to the corrector 14 a correction parameter using the updated corresponding points. If the detector 11 detects no change in the projection surface, and if the corresponding point calculator 12 outputs the previous corresponding points, the parameter calculator 13 calculates and outputs to the corrector 14 a correction parameter using the previous corresponding points.

While the parameter calculator 13 according to the present embodiment calculates the correction parameter for every certain number of frames of the captured images, that is, in each period when the detector 11 determines presence or absence of a change in the projection surface, the embodiment is not limited thereto. The parameter calculator 13, for example, may calculate the correction parameter when the detector 11 detects a change in the projection surface and when the corresponding point calculator 12 newly calculates and outputs the corresponding points corresponding to the captured image obtained after the projection surface is changed. In this case, when the detector 11 detects no change in the projection surface, the corrector 14 at a subsequent stage may correct the input image using a previous correction parameter stored in a certain storage area inside or outside the image processing apparatus 10A.

The correction parameter according to the present embodiment is calculated by comparing the input image with the captured image of the projection surface onto which the projection image corresponding to the input image is projected. As described above, the captured image is obtained by the image capturing apparatus 2 capturing the projection surface including at least the area onto which the projection image is projected. The captured image exhibits a state where the brightness and the color of the projection image, which is projected onto the projection surface correspondingly to the input image by the projection apparatus 1, are changed by the influence of the material and the shape of the projection surface. The present embodiment calculates a correction parameter that brings a state of the projection image changed by the influence of the projection surface closer to a state of the projection image not subjected to influence of the projection surface. The state of the projection image not subjected to influence of the projection surface is calculated by multiplying the input image by a unique parameter determined by the optical characteristics and the mechanical characteristics of the projection apparatus 1. The parameter calculator 13 compares the input image multiplied by the unique parameter of the projection apparatus 1 with the captured image of the projection surface received from the image capturing apparatus 2 for each pair of corresponding pixels. Thus, the parameter calculator 13 calculates a correction parameter corresponding to the difference.

The corrector 14 corrects the input image using the correction parameter received from the parameter calculator 13 and outputs the corrected input image to the projection apparatus 1. For example, in the correction, the luminance values of the three channels of the red component, the green component, and the blue component are corrected in each pixel of the input image on the basis of the correction parameter of the corresponding pixel. Based on the input image in which the luminance values of the respective color components are corrected in each pixel, the projection apparatus 1 projects the projection image onto the projection surface. Thus, the projection apparatus 1 can project, onto the projection surface, a desired projection image in which a change in the brightness and the color due to the influence of the color and the pattern of the projection surface is canceled out.

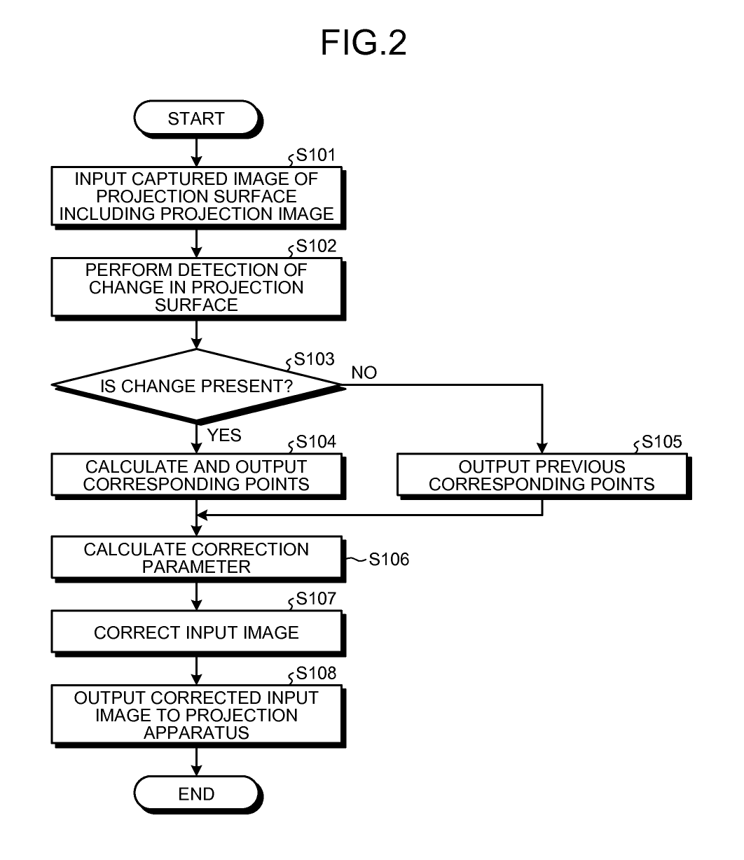

The following describes an outline of the operation of the image processing apparatus 10A according to the present embodiment with reference to FIG. 2. FIG. 2 is a flowchart performed by the image processing apparatus 10A. The image processing apparatus 10A repeatedly performs the series of processing illustrated in the flowchart in FIG. 2 in a certain control period (e.g., for every certain number of frames of the captured images). The image processing apparatus 10A occasionally receives the input image.

If the processing illustrated in the flowchart in FIG. 2 is started, the image processing apparatus 10A receives the captured image output from the image capturing apparatus 2, that is, the captured image of the projection surface including the area onto which the projection image is projected by the projection apparatus 1 (Step S101).

The detector 11 then performs detection of a change in the projection surface using the captured image of the projection surface received at Step S101 (Step S102). If the detector 11 detects a change in the projection surface, the detector 11 outputs change information indicating presence of a change to the corresponding point calculator 12, whereas if the detector 11 detects no change in the projection surface, the detector 11 outputs change information indicating absence of a change to the corresponding point calculator 12.

The corresponding point calculator 12 then determines whether the change information received from the detector 11 indicates presence of a change (Step S103). If the result of the determination is affirmative, the corresponding point calculator 12 calculates corresponding points between the captured image obtained after the projection surface is changed and the input image on the basis of the captured image of the projection surface received at Step S101 (that is, the captured image obtained after the projection surface is changed) and the input image, and outputs the corresponding points to the parameter calculator 13 (Step S104), whereas if the result of the determination is negative, the corresponding point calculator 12 outputs previous corresponding points stored in the certain storage area to the parameter calculator 13 (Step S105).

The parameter calculator 13 then calculates a correction parameter on the basis of the input image, the captured image of the projection surface received at Step S101, and the corresponding points received from the corresponding point calculator 12 (Step S106). The parameter calculator 13 then outputs the calculated correction parameter to the corrector 14.

The corrector 14 then corrects the input image using the correction parameter received from the parameter calculator 13 (Step S107). The corrector 14 then outputs the corrected input image to the projection apparatus 1 (Step S108).

As described in detail with a specific example, according to the present embodiment, the corresponding points between the input image and the captured image of the projection surface are always appropriately retained even when the relative positional relation between the projection apparatus 1 and the projection surface is changed (the projection surface is changed in the description above). This makes it possible to correctly calculate the correction parameter and project, onto various projection surfaces, a desired projection image in which a change in the brightness and the color due to the influence of the color and the pattern of the projection surface is canceled out.

### Second Embodiment

The following describes a second embodiment. In the second embodiment, the distance between the projection apparatus 1 and the projection surface is measured to detect a change in the projection surface using the distance, and a change in the luminance of the projection image due to the change in the projection surface is estimated to reflect the estimated change in the luminance in the correction parameter. The configuration of the second embodiment other than this point is the same as that of the first embodiment. In the following description, components common to those of the first embodiment are denoted by like reference numerals, and overlapping explanation thereof is appropriately omitted. The following mainly describes characteristic portions of the present embodiment.

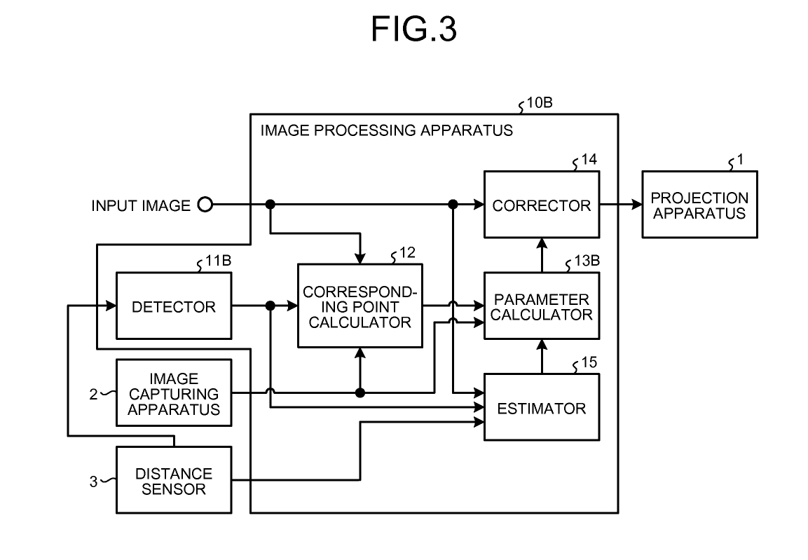

FIG. 3 is a block diagram of an image projection system according to the second embodiment. As illustrated in FIG. 3, the image projection system according to the present embodiment includes the projection apparatus 1, the image capturing apparatus 2, a distance sensor 3, and an image processing apparatus 10B.

The distance sensor 3 measures the distance between the projection apparatus 1 and the projection surface and outputs the measured distance to the image processing apparatus 10B. The distance sensor 3 may be various types of distance sensors that measure the distance to an object. Examples of the distance sensor 3 include, but are not limited to, a range sensor that measures a distance by detecting a phase difference between projection light and detection light, such as time of flight (TOF) range image sensor, a range sensor that measures a distance by projecting and detecting invisible light such as an infrared sensor, a range sensor that measures a distance using a plurality of sensor outputs such as a stereo camera. By providing such a range sensor near the projection apparatus 1, it is possible to measure the distance between the projection apparatus 1 and the projection surface.

The distance sensor 3 preferably measures, with a certain resolution, the distance between the projection apparatus 1 and each position in a predetermined range on the projection surface including at least the area onto which the projection image is projected. With the distance sensor 3 configured in this manner, an estimator 15, which will be described later, in the image processing apparatus 10B can estimate a change in the luminance of the projection image due to a change in the projection surface using the distance. Especially by using a distance sensor that uses invisible light such as a TOF range image sensor and an infrared sensor as the distance sensor 3, it is possible to measure the distance with higher accuracy without being affected by interference of the projection image projected from the projection apparatus 1 onto the projection surface.

As illustrated in FIG. 3, the image processing apparatus 10B according to the present embodiment includes a detector 11B, the corresponding point calculator 12, a parameter calculator 13B, the corrector 14, and the estimator 15. Because the configurations of the corresponding point calculator 12 and the corrector 14 are the same as those of the first embodiment, explanation thereof will be omitted.

The detector 11B detects a change in the projection surface using the distance received from the distance sensor 3. Specifically, the detector 11B calculates a temporal variation of the distance received from the distance sensor 3, for example. If the temporal variation of the distance exceeds a predetermined threshold, the detector 11B determines that the projection surface is changed. The temporal variation of the distance, for example, is calculated by accumulating changes in the distance in a certain time. The detector 11B determines whether the projection surface is changed using the distance every certain time. If the detector 11B determines that the projection surface is changed, the detector 11B outputs change information indicating presence of a change to the corresponding point calculator 12 and the estimator 15, whereas if the detector 11B determines that the projection surface is not changed, the detector 11B outputs change information indicating absence of a change to the corresponding point calculator 12 and the estimator 15.

While in the present embodiment a change in the projection surface is detected using the distance received from the distance sensor 3, a change in the projection surface may be detected using the captured image of the projection surface received from the image capturing apparatus 2 similarly to the first embodiment.

If the detector 11B detects a change in the projection surface, the estimator 15 estimates a change in the luminance of the projection image due to a change in the projection distance and the projection angle caused by the change in the projection surface on the basis of the input image and the distance received from the distance sensor 3. In other words, if the change information received from the detector 11B indicates that the projection surface is changed, the estimator 15 estimates a change in the luminance of the projection image after the change with respect to the projection image before the change on the basis of the input image and the distance. If the estimator 15 newly estimates a change in the luminance of the projection image, the estimator 15 outputs an estimate indicating the estimated change in the luminance to the parameter calculator 13B. By contrast, if the change information received from the detector 11B indicates that the projection surface is not changed, and if the estimator 15 does not newly estimate a change in the luminance of the projection image, the estimator 15 outputs a previous estimate stored in a certain storage area inside or outside the image processing apparatus 10B to the parameter calculator 13B.

The luminance of the projection image reproduced by projection light output from a light source of the projection apparatus 1 is known to be inversely proportional to the square of the distance from the light source of the projection apparatus 1 to the projection surface. In other words, it is estimated that an increase in the projection distance twofold reduces the projection luminance to one-fourth the original luminance. The luminance of the projection image is known to decrease by the cosine rule with respect to a difference between the normal line of the projection surface and the angle of incident light. Specifically, in a case where the angle of the normal line of the projection surface with respect to the projection light is changed from 0 degrees to 45 degrees, for example, it is estimated that the luminance of the projection image decreases by approximately 0.707 times the original luminance. From these relations, the estimator 15 estimates a change in the luminance of the projection image using a change in the projection distance and the projection angle caused by the change in the projection surface. As described above, the estimator 15 estimates that an increase in the distance from the projection apparatus 1 to the projection surface reduces the luminance of the projection image according to the change in the distance, thereby estimating that an increase in the angle of the normal line of the projection surface with respect to the projection light reduces the luminance of the projection image according to the increase in the angle.

The parameter calculator 13B calculates a correction parameter on the basis of the input image, the captured image of the projection surface received from the image capturing apparatus 2, the corresponding points received from the corresponding point calculator 12, and the estimate received from the estimator 15. The parameter calculator 13B outputs the calculated correction parameter to the corrector 14. In other words, the parameter calculator 13B calculates and outputs to the corrector 14 the correction parameter by adding the change in the luminance of the projection surface estimated by the estimator 15.

At this time, if the detector 11 detects a change in the projection surface, the corresponding point calculator 12 newly calculates and outputs corresponding points corresponding to the captured image obtained after the projection surface is changed, and the estimator 15 newly calculates and outputs an estimate, then the parameter calculator 13B calculates a correction parameter using the newly calculated corresponding points and the newly calculated estimate, and outputs the correction parameter to the corrector 14. By contrast, if the detector 11B detects no change in the projection surface, the corresponding point calculator 12 outputs previous corresponding points, and the estimator 15 outputs a previous estimate, then the parameter calculator 13B calculates a correction parameter using the previous corresponding points and the previous estimate and outputs the correction parameter to the corrector 14.

While the parameter calculator 13B according to the present embodiment calculates the correction parameter every certain time, that is, in each period when the detector 11B determines presence or absence of a change in the projection surface on the basis of the distance received from the distance sensor 3, the embodiment is not limited thereto. The parameter calculator 13B, for example, may calculate the correction parameter when the detector 11B detects a change in the projection surface, the corresponding point calculator 12 newly calculates and outputs the corresponding points corresponding to the captured image obtained after the projection surface is changed, and the estimator 15 newly calculates and outputs the estimate. In this case, when the detector 11B detects no change in the projection surface, the corrector 14 at a subsequent stage may correct the input image using a previous correction parameter stored in a certain storage area inside or outside the image processing apparatus 10B.

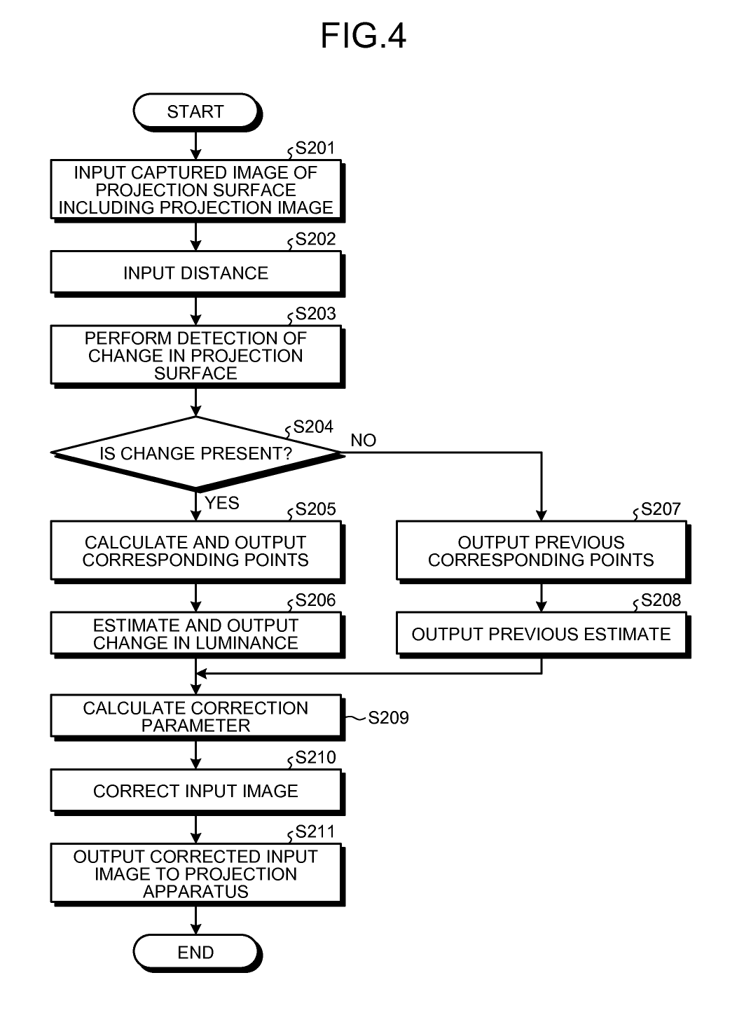

The following describes an outline of the operation of the image processing apparatus 10B according to the present embodiment with reference to FIG. 4. FIG. 4 is a flowchart performed by the image processing apparatus 10B. The image processing apparatus 10B repeatedly performs the series of processing illustrated in the flowchart in FIG. 4 in a certain control period (e.g., every certain time corresponding to the period when the detector 11B detects a change in the projection surface). The image processing apparatus 10B occasionally receives the input image.

When the processing illustrated in the flowchart in FIG. 4 is started, the image processing apparatus 10B receives the captured image output from the image capturing apparatus 2, that is, the captured image of the projection surface including the area onto which the projection image is projected by the projection apparatus 1 (Step S201).

The image processing apparatus 10B receives the distance output from the distance sensor 3, that is, the distance between the projection apparatus 1 and the projection surface (Step S202).

The detector 11B performs detection of a change in the projection surface using the distance received at Step S202 (Step S203). If the detector 11B detects a change in the projection surface, the detector 11B outputs change information indicating presence of a change to the corresponding point calculator 12 and the estimator 15, whereas if the detector 11B detects no change in the projection surface, the detector 11B outputs change information indicating absence of a change to the corresponding point calculator 12 and the estimator 15.

The corresponding point calculator 12 and the estimator 15 determine whether the change information received from the detector 11B indicates presence of a change (Step S204). If the result of the determination is affirmative, the corresponding point calculator 12 calculates corresponding points between the captured image obtained after the projection surface is changed and the input image based on the captured image of the projection surface received at Step S201 (that is, the captured image obtained after the projection surface is changed) and the input image. The corresponding point calculator 12 then outputs the corresponding points to the parameter calculator 13B (Step S205). The estimator 15 estimates a change in the luminance of the projection image due to the change in the projection surface on the basis of the input image and the distance received at Step S202, and outputs the estimate to the parameter calculator 13B (Step S206).

By contrast, if the result of the determination at Step S204 is negative, the corresponding point calculator 12 outputs previous corresponding points stored in the certain storage area to the parameter calculator 13B (Step S207). The estimator 15 outputs a previous estimate stored in the certain storage area to the parameter calculator 13B (Step S208).

The parameter calculator 13B then calculates a correction parameter on the basis of the input image, the captured image of the projection surface received at Step S201, the corresponding points received from the corresponding point calculator 12, and the estimate received from the estimator 15 (Step S209). The parameter calculator 13B then outputs the calculated correction parameter to the corrector 14.

The corrector 14 corrects the input image using the correction parameter received from the parameter calculator 13B (Step S210). The corrector 14 then outputs the corrected input image to the projection apparatus 1 (Step S211).

As described above, according to the present embodiment, when the relative positional relation between the projection apparatus 1 and the projection surface is changed (the projection surface is changed in the description above), a change in the luminance of the projection image due to the change in the projection distance and the projection angle is appropriately estimated and a correction parameter is calculated using the estimated estimate. Therefore, the correction parameter is correctly calculated without being affected by the change in the luminance of the projection image due to a change in the projection distance and the projection angle. Thus, onto various projection surfaces, a desired projection image can be projected in which a change in the brightness and the color due to the influence of the color and the pattern of the projection surface is canceled out.

### Third Embodiment

The following describes a third embodiment. In the third embodiment, the input image is geometrically transformed such that distortion of the projection image is removed; a change in the luminance of the projection image due to the change in the projection surface is estimated using the geometrically transformed input image and the distance; and the geometrically transformed input image is corrected using the correction parameter. The configuration of the third embodiment other than this point is the same as that of the second embodiment. In the following description, components common to those of the second embodiment are denoted by like reference numerals, and overlapping explanation thereof is appropriately omitted. The following mainly describes characteristic portions of the present embodiment.

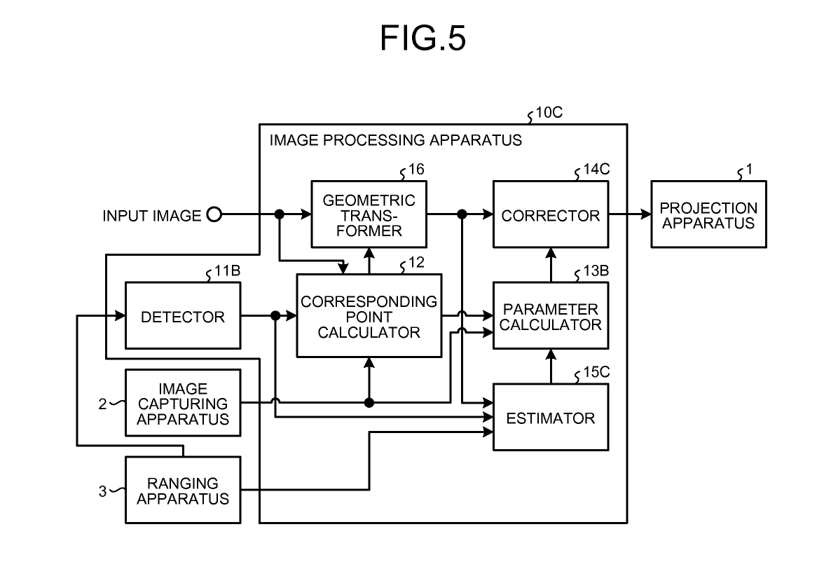

FIG. 5 is a block diagram of an image projection system according to the third embodiment. As illustrated in FIG. 5, the image projection system according to the present embodiment includes the projection apparatus 1, the image capturing apparatus 2, the distance sensor 3, and an image processing apparatus 10C.

As illustrated in FIG. 5, the image processing apparatus 10C according to the present embodiment includes the detector 11B, the corresponding point calculator 12, the parameter calculator 13B, a corrector 14C, an estimator 15C, and a geometric transformer 16. Because the configurations of the detector 11B, the corresponding point calculator 12, and the parameter calculator 13B are the same as those of the second embodiment, explanation thereof will be omitted.

The geometric transformer 16 geometrically transforms the input image so as to remove distortion of the projection image using the corresponding points output from the corresponding point calculator 12. The geometrically transformed input image is hereinafter referred to as a “geometrically transformed image”. Geometric transformation according to the present embodiment means geometrically transforming the input image so as to prevent distortion such as trapezoidal distortion in the projection image viewed from the image capturing apparatus 2. The geometric transformer 16 uses the corresponding points output from the corresponding point calculator 12, thereby geometrically transforming the input image serving as the original of the projection image such that the projection image has a desired shape on the captured image. The geometric transformer 16 outputs the geometrically transformed image obtained by geometrically transforming the input image to the estimator 15C and the corrector 14C.

When the detector 11B detects a change in the projection surface, the estimator 15C estimates a change in the luminance of the projection image due to a change in the projection distance and the projection angle caused by the change in the projection surface on the basis of the geometrically transformed image and the distance received from the distance sensor 3. In other words, if the change information received from the detector 11B indicates that the projection surface is changed, the estimator 15C estimates a change in the luminance of the projection image after the change with respect to the projection image before the change on the basis of the geometrically transformed image and the distance. If the estimator 15C newly estimates a change in the luminance of the projection image, the estimator 15C outputs an estimate indicating the estimated change in the luminance to the parameter calculator 13B. By contrast, if the change information received from the detector 11B indicates that the projection surface is not changed and the estimator 15C does not newly estimate a change in the luminance of the projection image, the estimator 15C outputs a previous estimate stored in a certain storage area inside or outside the image processing apparatus 10C to the parameter calculator 13B.

The corrector 14C corrects the geometrically transformed image received from the geometric transformer 16 using the correction parameter received from the parameter calculator 13B. The corrector 14C outputs the corrected geometrically transformed image to the projection apparatus 1.

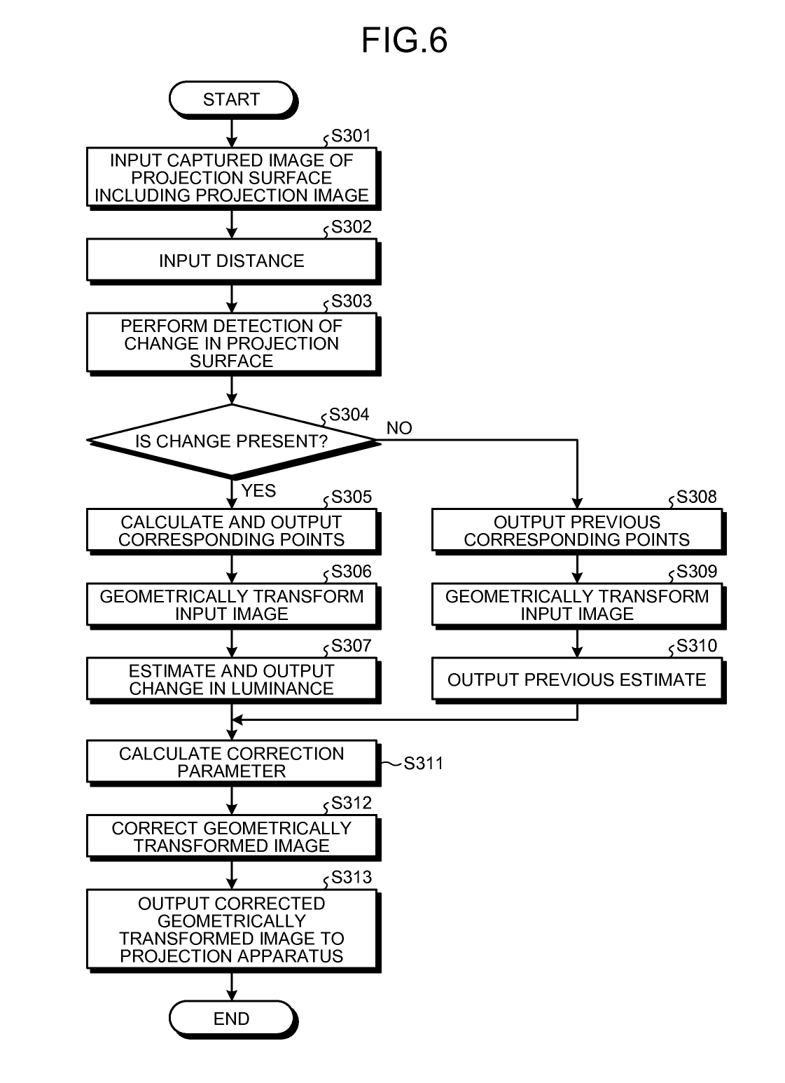

The following describes an outline of the operation of the image processing apparatus 10C according to the present embodiment with reference to FIG. 6. FIG. 6 is a flowchart performed by the image processing apparatus 10C. The image processing apparatus 10C repeatedly performs the series of processing illustrated in the flowchart in FIG. 6 in a certain control period (e.g., every certain time corresponding to the period when the detector 11B detects a change in the projection surface). The image processing apparatus 10C occasionally receives the input image.

When the processing illustrated in the flowchart in FIG. 6 is started, the image processing apparatus 10C receives the captured image output from the image capturing apparatus 2, that is, the captured image of the projection surface including the area onto which the projection image is projected by the projection apparatus 1 (Step S301).

The image processing apparatus 10C receives the distance output from the distance sensor 3, that is, the distance between the projection apparatus 1 and the projection surface (Step S302).

The detector 11B performs detection of a change in the projection surface using the distance received at Step S302 (Step S303). If the detector 11B detects a change in the projection surface, the detector 11B outputs change information indicating presence of a change to the corresponding point calculator 12 and the estimator 15C, whereas if the detector 11B detects no change in the projection surface, the detector 11B outputs change information indicating absence of a change to the corresponding point calculator 12 and the estimator 15.

The corresponding point calculator 12 and the estimator 15C determine whether the change information received from the detector 11B indicates presence of a change (Step S304). If the result of the determination is affirmative, the corresponding point calculator 12 generates corresponding points between the captured image obtained after the projection surface is changed and the input image on the basis of the captured image of the projection surface received at Step S301 (that is, the captured image obtained after the projection surface is changed) and the input image. The corresponding point calculator 12 then outputs the corresponding points to the parameter calculator 13B and the geometric transformer 16 (Step S305). The geometric transformer 16 geometrically transforms the input image using the corresponding points received from the corresponding point calculator 12 (Step S306). The geometric transformer 16 then outputs the geometrically transformed image to the estimator 15C and the corrector 14C. The estimator 15C estimates a change in the luminance of the projection image due to the change in the projection surface on the basis of the geometrically transformed image received from the geometric transformer 16 and the distance received at Step S302, and outputs the estimate to the parameter calculator 13B (Step S307).

By contrast, if the result of the determination at Step S304 is negative, the corresponding point calculator 12 outputs previous corresponding points stored in the certain storage area to the parameter calculator 13B and the geometric transformer 16 (Step S308). The geometric transformer 16 geometrically transforms the input image using the corresponding points received from the corresponding point calculator 12 (Step S309) and outputs the geometrically transformed image to the corrector 14C. The estimator 15C outputs a previous estimate stored in the certain storage area to the parameter calculator 13B (Step S310).

The parameter calculator 13B calculates a correction parameter on the basis of the input image, the captured image of the projection surface received at Step S301, the corresponding points received from the corresponding point calculator 12, and the estimate received from the estimator 15 (Step S311), and outputs the calculated correction parameter to the corrector 14C.

The corrector 14C corrects the geometrically transformed image received from the geometric transformer 16 using the correction parameter received from the parameter calculator 13B (Step S312), and outputs the corrected geometrically transformed image to the projection apparatus 1 (Step S313).

As described above, according to the present embodiment, the input image is geometrically transformed using the corresponding points, thereby correctly calculating the correction parameter while removing geometric distortion of the projection image viewed from the image capturing apparatus 2. Thus, onto various projection surfaces, a desired projection image can be projected in which a change in the brightness and the color due to the influence of the color and the pattern of the projection surface is canceled out.

### Fourth Embodiment

The following describes a fourth embodiment. The fourth embodiment describes variations of the method for detecting a change in the projection surface. As the method for detecting a change in the projection surface; in the first embodiment, the captured image received from the image capturing apparatus 2 is used, and in the second embodiment, the distance received from the distance sensor 3 is used. In the fourth embodiment, an example will be described in which a change in the projection surface is detected using information other than the projection image and the distance. The configuration of the fourth embodiment is the same as that of the third embodiment except that the method for detecting a change in the projection surface is different. In the following description, components common to those of the third embodiment are denoted by like reference numerals, and overlapping explanation thereof is appropriately omitted. The following mainly describes characteristic portions of the present embodiment.

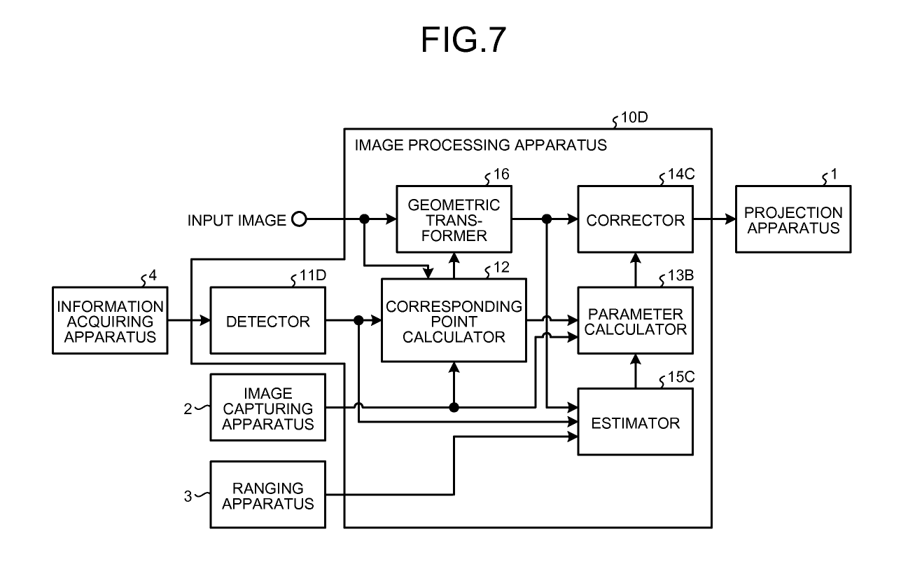

FIG. 7 is a block diagram of an image projection system according to the fourth embodiment. As illustrated in FIG. 7, the image projection system according to the present embodiment includes the projection apparatus 1, the image capturing apparatus 2, the distance sensor 3, an information acquiring apparatus 4, and an image processing apparatus 10D.

The information acquiring apparatus 4 acquires information used to detect a change in the projection surface (hereinafter, referred to as “change detection information”) and outputs it to the image processing apparatus 10D. The information acquiring apparatus 4 can be embodied in various configurations depending on the type of the change detection information. Specific examples of the change detection information will be described later.

As illustrated in FIG. 7, the image processing apparatus 10D according to the present embodiment includes a detector 11D, the corresponding point calculator 12, the parameter calculator 13B, the corrector 14C, the estimator 15C, and the geometric transformer 16. Because the configurations of the corresponding point calculator 12, the parameter calculator 13B, the corrector 14C, the estimator 15C, and the geometric transformer 16 are the same as those of the third embodiment, explanation thereof will be omitted.

The detector 11D detects a change in the projection surface using the change detection information received from the information acquiring apparatus 4. In other words, the detector 11D determines whether the projection surface is changed, using the change detection information received from the information acquiring apparatus 4. If the detector 11D determines that the projection surface is changed, the detector 11D outputs change information indicating presence of a change to the corresponding point calculator 12 and the estimator 15C, whereas if the detector 11D determines that the projection surface is not changed, the detector 11D outputs change information indicating absence of a change to the corresponding point calculator 12 and the estimator 15C.

The following describes specific examples of the change detection information acquired by the information acquiring apparatus 4 and used by the detector 11D to detect a change in the projection surface.

In a case where the projection surface is a moving object stopped at a certain position at certain time, for example, operational information on the moving object and attribute information on attributes of the moving object may be used as the change detection information. Specifically, in a case where the projection surface is the body of a train stopped at a platform of a station and that the projection apparatus 1 arranged on a ceiling of a station building projects a projection image onto the body of the train, for example, the detector 11D can detect the body of the train stopped at the platform of the station, that is, a change in the projection surface using a timetable (operational information) indicating arrival time and departure time of the train and attribute information such as a vehicle identification number for identifying the color and the shape of the body of the train, for example. Similarly, in a case where the projection surface is a moving object other than a train (e.g., a plane, a ship, a railway train, a bus, a car, and a monorail train), the detector 11D can detect a change in the projection surface on the basis of the operational information and the attribute information on the moving object.

In this example, the information acquiring apparatus 4 acquires the operational information and the attribute information on the moving object from an external server or the like as the change detection information and outputs them to the image processing apparatus 10D. The detector 11D of the image processing apparatus 10D determines whether the moving object serving as the projection surface is changed using time information on the current time acquired in the image processing apparatus 10D and the operational information and the attribute information on the moving object received from the information acquiring apparatus 4, for example. The detector 11D outputs change information corresponding to the determination result to the corresponding point calculator 12 and the estimator 15C.

A change in the projection surface may be detected on the basis of a change in the amount of reflected light on the projection surface, for example. Specifically, a single or a plurality of optical sensors that detect reflected light on the projection surface may be provided. Information on the amount of reflected light on the projection surface detected by the optical sensor may be used as the change detection information. The optical sensor has a simple configuration different from the image capturing apparatus 2 that captures the projection surface onto which the projection image is projected. The optical sensor may irradiate the projection surface with light and detect the reflected light or detect reflected light on the projection surface irradiated with natural light. The optical sensor may detect visible reflected light or detect invisible reflected light such as infrared rays.

In this example, the information acquiring apparatus 4 acquires and outputs to the image processing apparatus 10D the information on the amount of reflected light on the projection surface from the optical sensor as the change detection information. The detector 11D of the image processing apparatus 10D, for example, calculates a temporal variation (variation in a certain time) of the amount of reflected light on the projection surface using the change detection information received from the information acquiring apparatus 4. The detector 11D determines whether the projection surface is changed, on the basis of whether the temporal variation of the amount of reflected light exceeds a predetermined threshold, and outputs change information corresponding to the determination result to the corresponding point calculator 12 and the estimator 15C.

A change in the projection surface may be detected on the basis of a change in the volume of sound reflected by the projection surface, for example. Specifically, a single or a plurality of sound sensors that detect sound waves reflected by the projection surface may be provided. Information on the volume of reflected sound from the projection surface detected by the sound sensor may be used as the change detection information. The sound sensor may output sound waves to the projection surface and detect sound waves reflected by the projection surface or detect sound waves of ambient sound reflected by the projection surface.

In this example, the information acquiring apparatus 4 acquires and outputs to the image processing apparatus 10D the information on the volume of reflected sound from the projection surface from the sound sensor as the change detection information. The detector 11D of the image processing apparatus 10D, for example, calculates a temporal variation (variation in a certain time) of the volume of reflected sound from the projection surface using the change detection information received from the information acquiring apparatus 4. The detector 11D determines whether the projection surface is changed on the basis of whether the temporal variation of the volume of reflected sound exceeds a predetermined threshold, and outputs change information corresponding to the determination result to the corresponding point calculator 12 and the estimator 15C.

In the description above, the projection apparatus 1 does not move, and a change in the projection surface is detected as a change in the relative positional relation between the projection apparatus 1 and the projection surface. In a case when detecting a change in the relative positional relation between the projection apparatus 1 and the projection surface, which includes movement of the projection apparatus 1, information on the amount of movement of the projection apparatus 1 may be used as the change detection information. Examples of the information on the amount of movement of the projection apparatus 1 include, but are not limited to, information output from an acceleration sensor, a gyro sensor, or the like provided to the projection apparatus 1.

In this case, the information acquiring apparatus 4 acquires and outputs to the image processing apparatus 10D the information on the amount of movement of the projection apparatus 1 from the acceleration sensor, the gyro sensor, or the like provided to the projection apparatus 1 as the change detection information. The detector 11D of the image processing apparatus 10D, for example, calculates a temporal variation (variation in a certain time) of the amount of movement of the projection apparatus 1 using the change detection information received from the information acquiring apparatus 4. The detector 11D determines whether the relative positional relation between the projection apparatus 1 and the projection surface is changed on the basis of whether the temporal variation of the amount of movement of the projection apparatus 1 exceeds a predetermined threshold, and outputs change information corresponding to the determination result to the corresponding point calculator 12 and the estimator 15C.

The explanation has been made of the variations of the method for detecting a change in the projection surface (change in the relative positional relation between the projection apparatus 1 and the projection surface). The detector 11D may detect a change in the projection surface (change in the relative positional relation between the projection apparatus 1 and the projection surface) by appropriately combining these methods with the method described in the first embodiment or the second embodiment. In a case where the projection surface is a moving object stopped at a certain position at certain time, for example, if it is estimated that the moving object serving as the projection surface is changed using the time information on the current time and the operational information and the attribute information on the moving object received from the information acquiring apparatus 4 and the temporal variation of the captured image received from the image capturing apparatus 2 or the distance received from the distance sensor 3 exceeds the predetermined threshold, then the detector 11D may determine that the projection surface is changed (the relative positional relation between the projection apparatus 1 and the projection surface is changed).

The present embodiment uses the configuration of the image processing apparatus 10C according to the third embodiment as the base and is provided with the detector 11D instead of the detector 11B of the image processing apparatus 10C according to the third embodiment. Alternatively, the present embodiment may use the configuration of the image processing apparatus 10A according to the first embodiment or the image processing apparatus 10B according to the second embodiment as the base and be provided with the detector 11D instead of the detector 11 or 11B, respectively.

While the information acquiring apparatus 4 according to the present embodiment acquires the change detection information, the information acquiring apparatus 4 may also acquire information besides the change detection information. In a case where a person detecting apparatus is provided to detect presence of a person at a position overlapping with the projection surface using the captured image of the projection surface captured by the image capturing apparatus 2, for example, if the person detecting apparatus detects a person, the information acquiring apparatus 4 may acquire the information. In this case, if the person detecting apparatus detects a person and the information acquiring apparatus 4 acquires the information, then the image processing apparatus 10D may stop outputting an image to the projection apparatus 1, thereby interrupting projection of the projection image performed by the projection apparatus 1.

As described above, according to the present embodiment, even when the relative positional relation between the projection apparatus 1 and the projection surface is changed (the projection surface is changed in the description above), the change is accurately detected and the corresponding points is appropriately retained. This makes it possible to correctly calculate the correction parameter and project, onto various projection surfaces, a desired projection image in which a change in the brightness and the color due to the influence of the color and the pattern of the projection surface is canceled out.

Supplementary Explanation

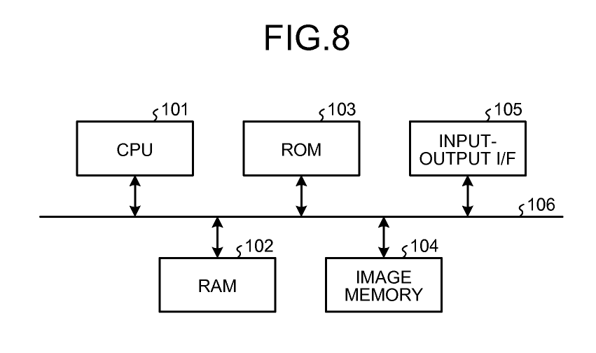

The processing units (the detector 11 (11B and 11D), the corresponding point calculator 12, the parameter calculator 13 (13B), the corrector 14, the estimator 15, and the geometric transformer 16) of the image processing apparatus 10A (10B, 10C, and 10D) according to the embodiments above may be provided as hardware or software (computer program) cooperating with the hardware. To provide the processing units as software, the image processing apparatus 10A (10B, 10C, and 10D) may have a hardware configuration of a typical computer illustrated in FIG. 8, for example. The hardware configuration includes a processor circuit such as a central processing unit (CPU) 101, storage devices such as a random access memory (RAM) 102, a read only memory (ROM) 103, and an image memory 104, an input-output interface (I/F) 105 to which an external device is connected, and a bus 106 that connects the units.

The computer program executed by the image processing apparatus 10A (10B, 10C, and 10D) according to the embodiments above is recorded in a computer-readable recording medium such as a compact disc read only memory (CD-ROM), a flexible disk (FD), a compact disc recordable (CD-R), and a digital versatile disc (DVD) as an installable or executable file and provided as a computer program product.

The computer program executed by the image processing apparatus 10A (10B, 10C, and 10D) according to the embodiments above may be stored in a computer connected to a network such as the Internet, and provided by being downloaded via the network. The computer program executed by the image processing apparatus 10A (10B, 10C, and 10D) according to the embodiments above may be provided or distributed via a network such as the Internet. The computer program executed by the image processing apparatus 10A (10B, 10C, and 10D) according to the embodiments above may be embedded and provided in the ROM 103, for example.

The computer program executed by the image processing apparatus 10A (10B, 10C, and 10D) according to the embodiments above has a module configuration including the processing units (the detector 11 (11B and 11D), the corresponding point calculator 12, the parameter calculator 13 (13B), the corrector 14, the estimator 15, and the geometric transformer 16) of the image processing apparatus 10A (10B, 10C, and 10D). In actual hardware, the CPU 101 (processor circuit), for example, reads and executes the computer program from the storage medium so as to load the processing units on the RAM 102 (main memory). Thus, the processing units are generated on the RAM 102 (main memory). A part or all of the processing units of the image processing apparatus 10A (10B, 10C, and 10D) according to the embodiments above may be provided as dedicated hardware such as an application specific integrated circuit (ASIC) and a field-programmable gate array (FPGA).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
a corresponding point calculator that calculates corresponding points between an input image and a captured image including a projection surface onto which a projection image is projected, the projection image being generated from the input image;
a parameter calculator that calculates a correction parameter based on the input image, the captured image, and the corresponding points;
a corrector that corrects pixel values of the input image using the correction parameter with respect to each color component; and
a detector that detects a change in the projection surface, wherein
when the detector detects the change in the projection surface, the corresponding point calculator updates the corresponding points for the change, and the parameter calculator calculates the correction parameter based on the updated corresponding points.

2. The apparatus according to claim 1, wherein the corrector corrects pixel values of the input image so as to cancel an effect of reflection characteristics of the projection surface.

3. The apparatus according to claim 1, further comprising:
an estimator that estimates a change in luminance of the projection image due to the change in the projection surface based on the input image and a distance between the projection surface and a projection apparatus projecting the projection image onto the projection surface and outputs an estimated amount, wherein
the parameter calculator calculates the correction parameter based on the estimated amount.

4. The apparatus according to claim 3, further comprising:
a geometric transformer that geometrically transforms the input image using the corresponding points, wherein
the estimator estimates the change in the luminance of the projection image based on the input image that is geometrically transformed.

5. The apparatus according to claim 4, wherein
the corrector corrects pixel values of the input image that is geometrically transformed.

6. The apparatus according to claim 1, wherein the corresponding point calculator calculates the corresponding points based on the captured image of a projection surface onto which a visible light projection image is projected and the input image corresponding to the visible light projection image.

7. The apparatus according to claim 1, wherein the corresponding point calculator calculates the corresponding points based on the captured image of a projection surface onto which an invisible light projection image is projected and the input image corresponding to the invisible light projection image.

8. The apparatus according to claim 1, wherein the detector detects the change in the projection surface using the captured image of the projection surface.

9. The apparatus according to claim 1, wherein the detector detects the change in the projection surface using a distance between the projection surface and a projection apparatus projecting the projection image onto the projection surface.

10. The apparatus according to claim 1, wherein
the projection surface is a moving object stopped at a certain position at certain time, and
the detector detects the change in the projection surface using time information indicating current time, operational information on the moving object, and attribute information indicating an attribute of the moving object.

11. The apparatus according to claim 10, wherein the moving object is a train.

12. An image projection system comprising:
the image processing apparatus according to claim 1;
a projection apparatus which projects the projection image onto the projection surface; and
an image capturing apparatus which captures the captured image.

13. The image projection system according to claim 12, further comprising a distance sensor that measures a distance between the projection apparatus and the projection surface.

14. An image processing method comprising:
calculating corresponding points between an input image and a captured image including a projection surface onto which a projection image is projected, the projection image being generated from the input image;
calculating a correction parameter based on the input image, the captured image, and the corresponding points;
correcting pixel values of the input image using the correction parameter with respect to each color component; and
detecting a change in the projection surface, wherein
when the change in the projection surface is detected,
in the calculating the corresponding points, the corresponding points is updated, and
in the calculating the correction parameter, the correction parameter is calculated based on the updated corresponding points.

15. A computer program product comprising a computer-readable medium including programmed instructions to correct an input image using a captured image of a projection surface onto which a projection image corresponding to the input image is projected, the instructions causing a computer to execute:
calculating corresponding points between an input image and a captured image including a projection surface onto which a projection image is projected, the projection image being generated from the input image;
calculating a correction parameter based on the input image, the captured image, and the corresponding points;
correcting pixel values of the input image using the correction parameter with respect to each color component; and
detecting a change in the projection surface, wherein
when the change in the projection surface is detected,
in the calculating the corresponding points, the corresponding points is updated, and
in the calculating the correction parameter, the correction parameter is calculated based on the updated corresponding points.

16. An image processing apparatus comprising:
a corresponding point calculator that calculates corresponding points between an input image and a captured image including a projection surface onto which a projection image is projected, the projection image being generated from the input image;
a parameter calculator that calculates a correction parameter based on the input image, the captured image, and the corresponding points;
a corrector that corrects pixel values of the input image using the correction parameter with respect to each color component;
a detector that detects a change in a relative positional relation between the projection surface and a projection apparatus projecting the projection image onto the projection surface;
and
an estimator that estimates a change in luminance of the projection image due to the change in the positional relation based on the input image and a distance between the projection apparatus and the projection surface and outputs an estimated amount, wherein
when the detector detects the change in the positional relation, the corresponding point calculator updates the corresponding points for the change, and the parameter calculator calculates the correction parameter based on the updated corresponding points and the estimated amount.
